(19) United States
(12) Patent Application Publication
(10) Pub. No.: US 2025/0241292 A1
(43) Pub. Date: Jul. 31, 2025

(54) MODULAR UNIVERSAL BIRD PERCH DETERRENT

(71) Applicant: Preformed Line Products Company, Cleveland, OH (US)

(72) Inventors: Nicholas Lees, Lakewood, OH (US); Robin Bartlett, Painesville, OH (US); Mark Burns, Macedonia, OH (US); Ben Ciesielczyk, Madison, OH (US); Douglas Bell, Solon, OH (US)

(21) Appl. No.: 19/041,493

(22) Filed: Jan. 30, 2025

Related U.S. Application Data
(60) Provisional application No. 63/626,831, filed on Jan. 30, 2024.

(51) Int. Cl. A01M 29/32

(52) U.S. Cl. CPC A01M 29/32

(57) ABSTRACT

A bird perch deterrent system includes a platform, a protrusion, and a finger. The protrusion includes a wall extended from the platform in a normal direction, and along the platform in a longitudinal direction substantially perpendicular to the normal direction. The protrusion also includes a crossmember extended from the wall in a lateral direction substantially perpendicular to the longitudinal direction and the normal direction, where the crossmember extends from an end of the wall opposite the platform in the normal direction. The finger is fixed with the protrusion, where the finger extends from the protrusion and the platform in the normal direction.

### CROSS REFERENCE TO RELATED APPLICATIONS

The application claims priority to and the benefit of U.S. Provisional Patent Application No. 63/626,831, filed on Jan. 30, 2024, entitled “Modular Universal Bird Perch Deterrent”, which we incorporate by reference in its entirety.

### BACKGROUND

Currently, there are many types of bird perch deterrent (BPD) systems available in the market. The problem currently is that there are many part numbers and variations that are required based on what type of structure the BPD is being mounted to, which leads to confusion for customers at times and difficulties to stock products since the available structure types are as numerous as the product selection of BPDs. Further, such BPDs may be limited to certain structure types, dimensional constraints and the like.

### BRIEF DESCRIPTION

The innovation described herein describes a modular bird perch deterrent system that may be mounted to various structure types and through various methods based on installer requirements. In varying embodiments, the modular bird perch deterrent system can be strapped or otherwise secured to metal Davit arms, angle irons, C-channels and other components. The modular bird perch deterrent system may also be bolted to wood cross arms and pole tops. The modular design for the deterrent height further enables customers to choose the heights of the deterrents and if they want, for example, 8″ or 4″ spacing between deterrents.

According to one aspect, a bird perch deterrent system includes a platform, a protrusion, and a finger. The protrusion includes a wall extended from the platform in a normal direction, and along the platform in a longitudinal direction substantially perpendicular to the normal direction. The protrusion also includes a crossmember extended from the wall in a lateral direction substantially perpendicular to the longitudinal direction and the normal direction, where the crossmember extends from an end of the wall opposite the platform in the normal direction. The finger is fixed with the protrusion, where the finger extends from the protrusion and the platform in the normal direction.

### BRIEF DESCRIPTION OF THE DRAWINGS

Aspects of the present disclosure are best understood from the following detailed description when read with the accompanying FIGS. and appendix. It is noted that, in accordance with the standard practice in the industry, various FIGS. are not drawn to scale. In fact, the dimensions of the various features may be arbitrarily increased or reduced for clarity of discussion.

FIG. 1 is a perspective view of an example bird perch deterrent (BPD) unit in accordance with aspect of the innovation.

FIG. 2 is a top view of the BPD unit of FIG. 1.

FIG. 3 is a side view of the BPD of FIG. 1 in accordance with some embodiments.

FIG. 4 is a bottom view of the BPD unit of FIG. 1 in accordance with some embodiments.

FIG. 5 is a perspective view of a finger included in the BPD unit of FIG. 1.

FIG. 6 is a front view of the finger of FIG. 5.

FIG. 7 is a side view of the finger of FIG. 5.

FIG. 8 is a perspective view of an example assembly of BPD units, including the BPD unit of FIG. 1.

FIG. 9 is a top view of the assembly of FIG. 8.

FIG. 10 is a side view of the of the assembly of FIG. 8.

FIG. 11 is a bottom view of the assembly of FIG. 8.

FIG. 12 is a perspective view of an example BPD unit assembly, according to another aspect.

FIG. 13 is a side view of the of the assembly of FIG. 12.

FIG. 14 is a bottom view of the assembly of FIG. 12.

FIG. 15 is a front view of the assembly of FIG. 12.

FIG. 16 is a front perspective view of a finger included in the BPD units of FIG. 12.

FIG. 17 is a bottom perspective view of the finger included in the BPD units of FIG. 12.

FIG. 18 is a perspective view of a base portion included in the BPD units of FIG. 12.

FIG. 19 is a perspective view of an example BPD unit assembly, according to another aspect.

FIG. 20 is a perspective view of a single BPD unit in the BPD unit assembly of FIG. 19.

FIG. 21 is a bottom perspective view of a finger included in the BPD unit assembly of FIG. 19.

FIG. 22 is a perspective view of a base portion included in the BPD units of FIG. 19.

FIG. 23 is a perspective view of an example BPD unit, according to another aspect.

FIG. 24 is a front perspective view of a finger included in the BPD unit of FIG. 23.

FIG. 25 is a perspective view of a base portion included in the BPD unit of FIG. 23.

FIG. 26 is an enlarged, partial perspective view of an example BPD unit fixed to a segment of angle iron.

FIG. 27 is an enlarged, partial perspective view of an example BPD unit fixed to a wood crossarm.

FIG. 28 is an enlarged, partial perspective view of an example BPD unit fixed to an I-beam.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant FIGS. and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

In accordance with some embodiments, there is provided a modular Bird Perch Deterrent (BPD) system that will be used to mount to utility structures to keep birds from landing at locations utilities deem dangerous to the bird and the line. In such embodiments, the modular BPD system includes features enabling it to easily lock into additional BPD units to extend the length of this line. The modular BPD system includes BPD units that are configured with multiple locations for mounting using banding or screws to allow it to be attached to a large variety of structures. Each BPD unit includes a channel enabling the unit to be easily placed on angle iron when necessary and strapped to it to keep in place. The aforementioned BPD system may include a substantially perpendicular member (e.g., a modular component) suitably configured to function as the deterrent part of the system. That is, the part extruding or extending substantially perpendicularly or substantially straight up, which will keep birds from landing in the desired location. The attachment of this modular system is fluid, and allows the user to decide what height the deterrent should be for each location. Spacing between the deterrent section (e.g., the substantially perpendicular member) of two connected BPD units may be in the range of about 8″. In some embodiments, an optional intermediary member may be installed in the center of the BPD unit, which would allow additional deterrent sections to be added making the space between substantially perpendicular components in the range of about 4″. This section will use the same modular feature as the original product. In some embodiments, the intermediary member may be removably affixed to the BPD unit via a window cut section of a U-shaped member of the BPD unit and may include a feature enabling it to be banded to the BPD unit and utility structure. According to some embodiments, the intermediary member may also have an option to be mounted to the top of a pole using a different insert in the tool. The modular BPD system disclosed herein will not harm birds as some others on the market do using sharp points.

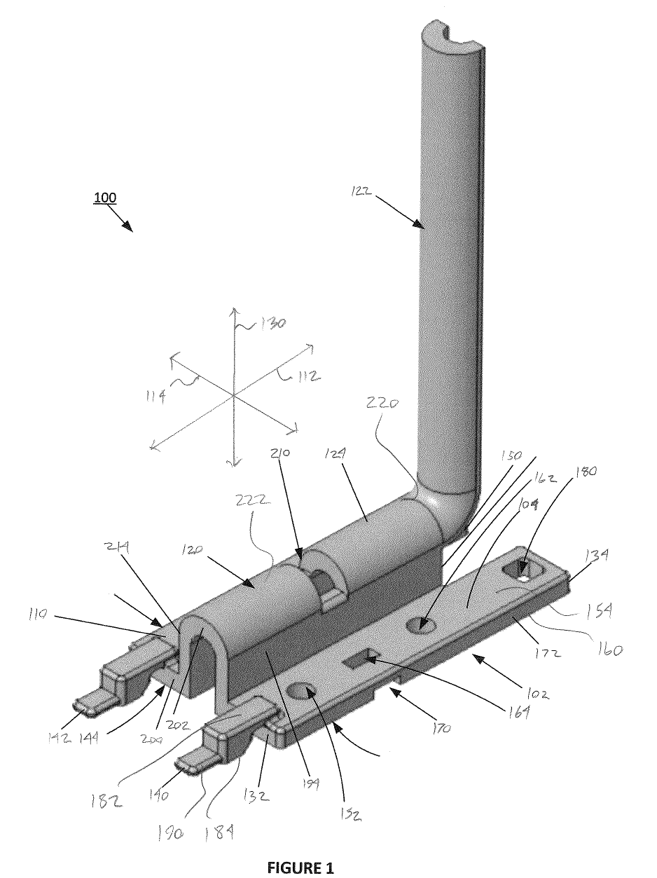

Turning now to FIG. 1, there is shown an example modular bird perch deterrent (BPD) unit 100 for use in a modular bird perch deterrent system in accordance with some embodiments. As shown in FIG. 1, the BPD unit 100 includes a platform 102 that is a base formed from a first substantially planar member 104 and a second opposing substantially planar member 110 that extend in a longitudinal direction of the BPD unit 100 indicated by an arrow 112, and in a lateral direction of the BPD unit 100 substantially perpendicular to the longitudinal direction, indicated by an arrow 114.

The BPD unit 100 also includes a protrusion 120 that is an inverted U-shaped member disposed in the longitudinal direction, along the long axis of the first substantially planar member 104 and the second substantially planar member 110. The BPD unit 100 also includes a first finger 122 that is a substantially perpendicular member extending from the protrusion 120. As such, the first finger 122 is fixed with a crossmember 124, where the first finger 122 extends from the protrusion 120 and the platform 102 in a normal direction substantially perpendicular to the longitudinal direction and the lateral direction, indicated by an arrow 130.

As illustrated in FIG. 1, the first substantially planar member 104 includes a first end 132 and a second end 134 opposite the first end 132 in the longitudinal direction. The first substantially planar member 104 also includes a first link 140 extended from the first end 132 of the first substantially planar member 104, opposite the first finger 122. The second substantially planar member 110 includes a corresponding second link 142 extending from a first end 144 of the second substantially planar member 110, substantially parallel to the first link 140 of the first substantially planar member 104. The first substantially planar member 104 includes a second end 150 opposite the first end 144 in the longitudinal direction.

The first substantially planar member 104 defines a first hole 152 extending through the first substantially planar member 104 from a top surface 154 to a bottom surface 160 thereof. The first substantially planar member 104 also includes a second hole 162 extending through the first substantially planar member 104 from the top surface 154 to the bottom surface 160.

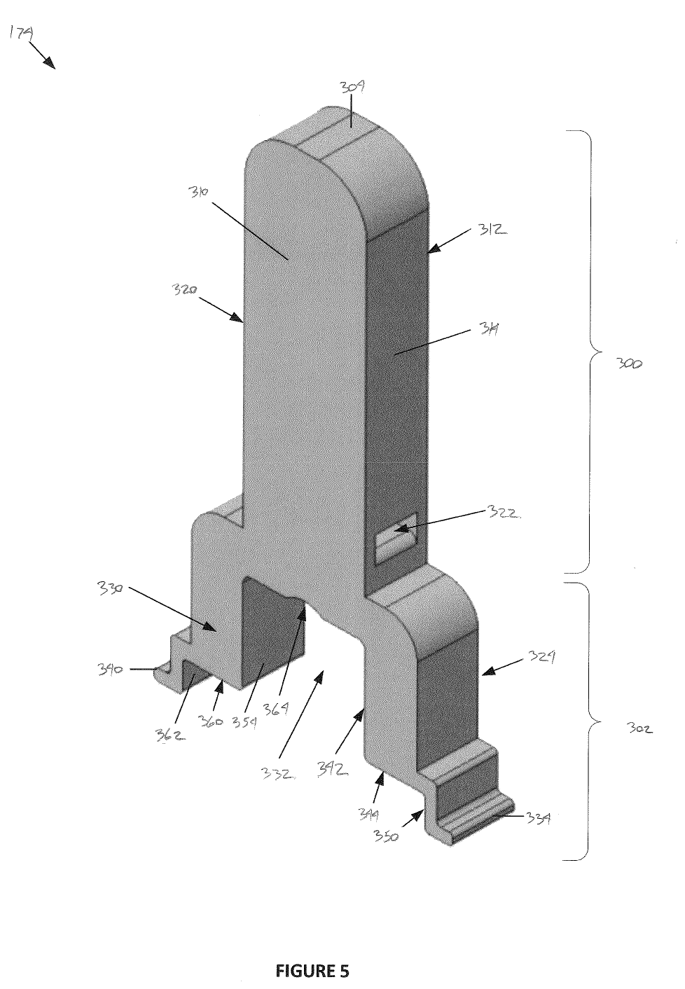

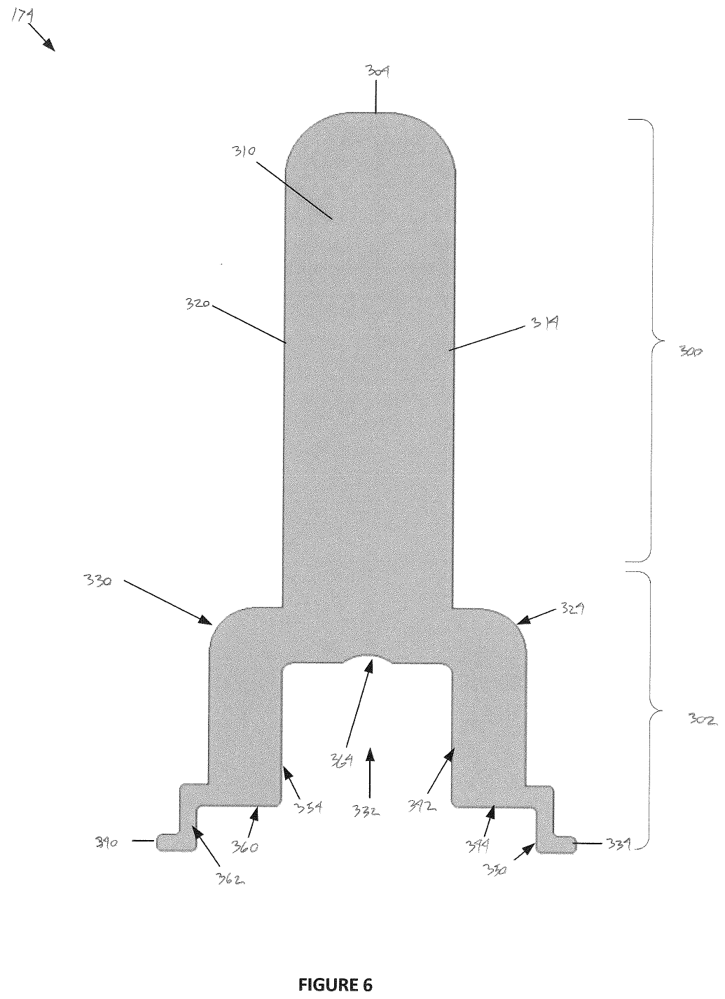

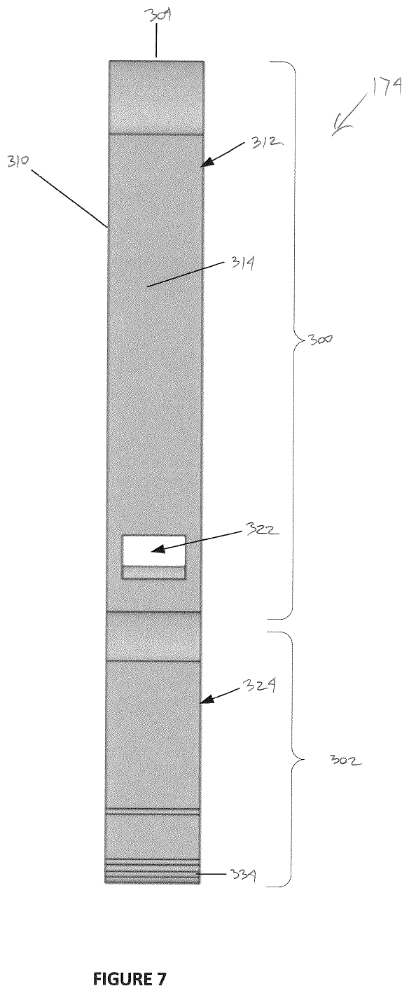

As illustrated in FIG. 1, the first substantially planar member 104 also defines an intermediary slot 164 that is a through hole extended through the platform 102 in the normal direction. An intermediary indent 170 is located on the bottom surface 160 of the first substantially planar member 104, and aligned with the intermediary slot 164. The intermediary indent 170 extending from the intermediary slot 164 to an exterior side 172 of the first substantially planar member 104. In some embodiments, the intermediary slot 164 is configured to removably receive a second finger 174, as illustrated in FIGS. 5-11.

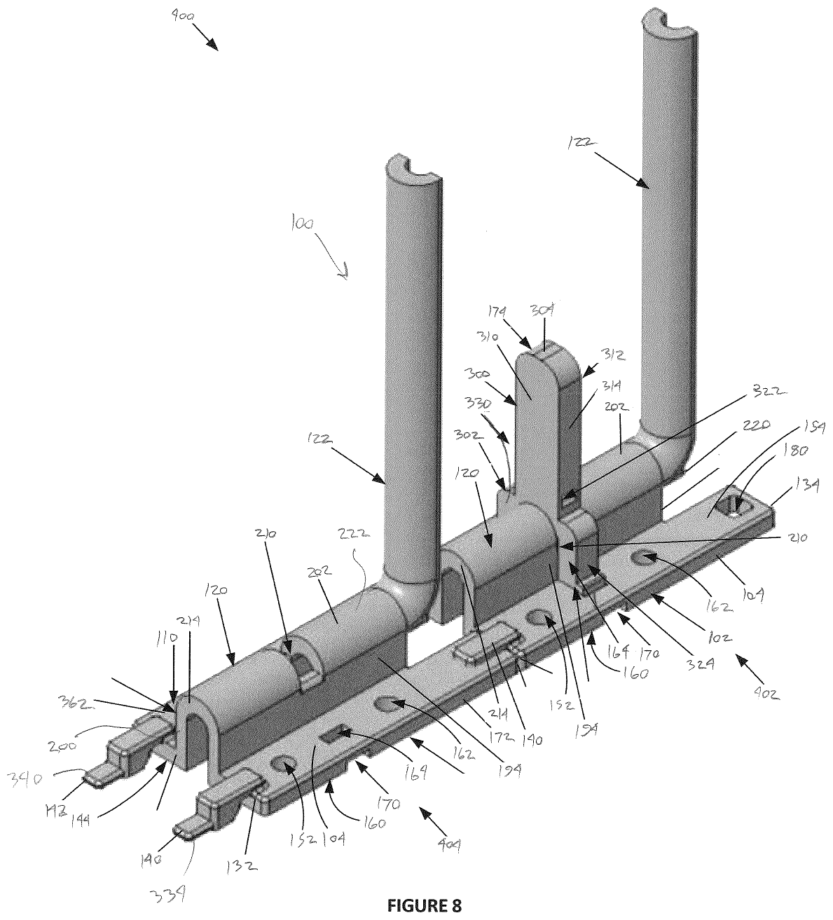

The first substantially planar member 104 further includes an attachment opening 180 located at the second end 134, and configured to engage a first link 140 of a second BPD unit 100 (as discussed below with respect to FIGS. 8-11). In this regard, the first substantially planar member 104 includes the second end 134 opposite the first end 132 in the longitudinal direction, the platform 102 defines the opening 180 extended in the normal direction. The opening 180 is located closer to the second end 134 of the platform 102 as compared to the first end 132.

In this regard, the first link 140 includes a bridge 182 extended beyond the first end 132 in the longitudinal direction, where the bridge 182 is offset from, and clear of the platform 102 at the first substantially planar member 104 in the normal direction. The first link 140 also includes a lug 184 fixed with the bridge 182 at an end of the bridge 182 opposite the platform 102 in the longitudinal direction.

The opening 180 and the lug 184 form similar shaped surfaces in the normal direction, and are sized to engage each other in a snug fit relationship that obstructs relative rotation between the lug 184 and the platform 102. The similar shaped surfaces of the lug 184 and the opening 180 are complementary such that the lug 184 may be inserted into or out of the opening 180 in the normal direction.

The bridge 182 spaces the lug 184 from the first end 132 by a first distance in the longitudinal direction, and the opening 180 is spaced from the second end 134 by a second distance in the longitudinal direction less than the first distance. With this construction, the BPD unit 100, as a first BPD, may engage a second BPD having a similar design, where the bridge 182 of the first BPD extends over the second end 134 of the second BPD, and the lug 184 of the first BPD extends into the opening 180 of the second BPD. Furthermore, a plurality of similar BPDs including the BPD unit 100 may form a repeating pattern of engagement between successive BPDs in the longitudinal direction.

The first link 140 includes a tab 190 fixed with the lug 184, where the tab 190 extends from the lug 184 and the platform 102 in the longitudinal direction. The platform 102 defines a second end indent 192 at a side of the first substantially planar member 104 opposite the first wall 194 in the normal direction. The second end indent 192 extends from the attachment opening 180 in the longitudinal direction, and the tab 190 engages the second end indent 192. In an embodiment, the tab 190 and the second end indent 192 extend in the lateral direction from the attachment opening 180. The second link 142 includes similar features and functions in a similar manner as the first link 140 for engaging a second BPD at the second end 150 of the second substantially planar member 110. In view of this further description is omitted for the sake of brevity.

The protrusion 120 of the BPD unit 100 illustrated in FIG. 1 includes a first wall 194, an opposing second wall 200, and a crossmember 202 that extends upward from the first wall 194 and the second wall 200 in the normal direction. The crossmember 202 is fixed along the first wall 194 and the second wall 200 in the longitudinal direction, and extends between and connects the first wall 194 and the second wall 200 in the lateral direction. As shown in FIG. 1, the first wall 194 and the second wall 200 are fixed with and formed substantially perpendicularly relative to respective first substantially planar member 104 and second substantially planar member 110. Further, each of the first wall 194 and the second wall 200 respectively extend from the first end 132 of the first substantially planar member 104 and a first end of the second substantially planar member 110 a substantial distance in the longitudinal direction, along the long axis of the respective first substantially planar member 104 and second substantially planar member 110. That is, the first wall 194 and the second wall 200 extend to the first finger 122, respectively terminating prior to the second end 134 of the first substantially planar member 104 and the second end 150 of the second substantially planar member 110, as shown in the example embodiment of FIG. 1.

The crossmember 202 connects the first wall 194 and the second wall 200 at opposite ends of the crossmember 202 in the lateral direction. In this manner, the first substantially planar member 104, the first wall 194, the crossmember 202, the second wall 200, and the second substantially planar member 110, in that order, form a continuous body across the BPD unit 100 in the lateral direction and the normal direction.

The protrusion 120 extends between and connects the first wall 194 and the second wall 200 in the lateral direction. More specifically, the protrusion 120 extends from and connects sides of the first wall 194 and the second wall 200 opposite the first substantially planar member 104 and the second substantially planar member 110 in the normal direction. As such, the protrusion 120 is a crossmember extended from the first wall 194 and the second wall 200 in the lateral direction, where the crossmember 202 extends from and connects the ends of the first wall 194 and the second wall 200 opposite the platform 102 in the normal direction. With this construction, the protrusion 120 is fixed with the platform 102, and extended upward from the platform 102 in the normal direction, where the crossmember 202 supports the first finger 122.

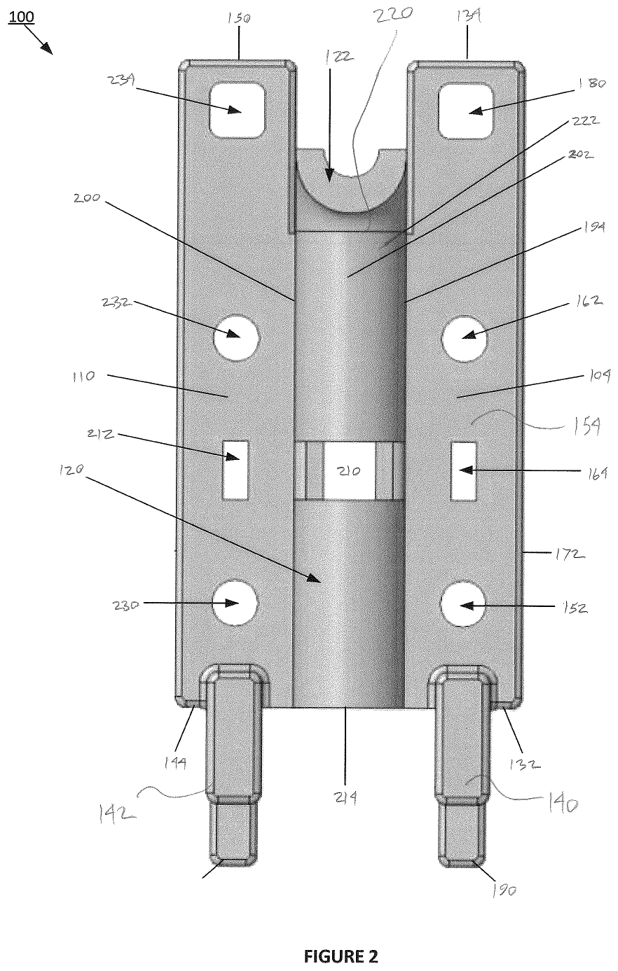

The protrusion 120 defines a window 210 in the crossmember 202. The window 210 is aligned with the intermediary slot 164 defined in the first substantially planar member 104, and an intermediary slot 212 (see FIG. 2) defined in the second substantially planar member 110. It will be appreciated that the attachment slot 212 of the second substantially planar member 110 is occluded by the protrusion 120 in the image shown in FIG. 1. With this construction, the platform 102 and the protrusion 120 respectively define the intermediary slots 164, 212 and the window 210 a same position in the longitudinal direction.

The crossmember 202 includes a first end 214 and a second end 220 in the longitudinal direction. The first finger 122 is located opposite the first end 214 of the crossmember 202, at the second end 220 thereof. The first finger 122 extends upward from the crossmember 202 in the normal direction at the second end 220.

The second finger 174 is an intermediary member fixed to the protrusion 120 at the first wall 194, the second wall 200, and the crossmember 202, where the second finger 174 is spaced from the first finger 122 along the crossmember 202 in the longitudinal direction. The second finger 174 is fixed with and extends from the crossmember 202 at a location closer to a midpoint between the first end 214 and the second end 220 of the crossmember 202 as compared to either the first end 214 or the second end 220.

In accordance with some embodiments, the first finger 122 and the second finger 174 may be removably affixed via suitable attachment means, e.g., friction coupling, adhesive coupling, mechanical coupling, etc. With this construction, the BPD unit 100 may be assembled by a user with an adjustable spacing or frequency of occurrence of the first finger 122 and the second finger 174 in the longitudinal direction.

In other embodiments, the first finger 122 and the second finger 174 may be integrally formed with the BPD unit 100. Furthermore, the first substantially planar member 104, the second substantially planar member 110, the first wall 194, the second wall 200, the crossmember 202, and the first finger 122 may be integrally formed with each other from a single unitary body. In such an embodiment, the first substantially planar member 104, the second substantially planar member 110, the first wall 194, the second wall 200, the crossmember 202, and the first finger 122 may be formed, for example, from a same body of pressed and cut sheet metal or a molded material.

As shown in FIG. 1, the protrusion 120 and the first finger 122 may have the same or similar arc of material, e.g., semi-circular, etc. In other embodiments, each of the protrusion 120 and the first finger 122 may have an angular cross-section, and the illustration of the semi-circular cross-section depicted in FIG. 1 is intended as one non-limiting example thereof.

As such, the first finger 122 is integrally formed with the crossmember 202, and the crossmember 202 and the first finger 122 form a continuous bent profile. The crossmember 202 forms the bent profile in the longitudinal direction, and the first finger 122 forms the bent profile in the normal direction. At the crossmember 202, the bent profile is curved or angled in the normal direction, and extends away from the first wall 194, the second wall 200, and the platform 102 in the normal direction.

As shown in FIG. 1, the protrusion 120 includes the window 210 located at a top surface 222 of the crossmember 202 in the normal direction. In this regard, the crossmember 202 defines the window 210 through the protrusion 120 in the normal direction. In some embodiments, the dimensions of the window 210 are configured to slideably engage the second finger 174 as discussed below.

As illustrated in FIG. 1, the window 210 is suitably aligned with the intermediary slots 164, 212, and corresponding intermediary indents 170, 224, thereby allowing for the attachment of the second finger 174. It will be appreciated that while not explicitly illustrated in FIG. 1, each of the first substantially planar member 104 and the second substantially planar member 110 are symmetrical, and in some embodiments, include mirrored features, e.g., holes, slots, indents. In other embodiments, the first substantially planar member 104 and the second substantially planar member 110 may be asymmetrical in orientation, e.g., non-mirrored holes, curved planar members, etc., in accordance with a particular utility structure to which the BPD system is affixed.

In accordance with some embodiments, the BPD unit 100 may be constructed of any suitable rigid, i.e., inflexible materials. In other embodiments, flexible or semi-rigid materials may be used in the construction of the BPD unit 100. For example and without limitation, the BPD unit 100 may comprise acrylonitrile butadiene styrene (ABS), polylactic acid (PLA), polyethylene terephthalate glycol (PETG), polyethylene terephthalate (PET), high-impact polystyrene (HIPS), thermoplastic polyurethane (TPU), aliphatic polyamides (nylon), carbon-fiber, a flexible non-conductive plastic, a rigid or semi-rigid plastic, or the like. It will be appreciated that metals or metal alloys may also be used when aesthetics require such usage, or when conductivity is not of a concern. Fabrication of such BPD units 100 may include, for example and without limitation, injection molding, blow-molding, additive manufacturing (e.g., fused deposition modeling, etc.), forging, CNC-formed, or the like, in accordance with the construction material used.

Turning now to FIG. 2, there is shown a top view of the BPD unit 100 of FIG. 1 in accordance with some embodiments. In FIG. 2, the first substantially planar member 104 and the second substantially planar member 110 are depicted in a mirrored implementation, such that each of the substantially planar members 104, 110 includes respective first holes 152, 230, intermediary slots 164, 212, second holes 162, 232 and attachment openings 180, 234.

Further, the embodiment shown in FIG. 2 illustrates that the aforementioned openings, holes, and slots e.g., 152, 162, 164, 180, 212, 230, 232, and 234 are located at mirrored positions relative to each substantially planar member 104 and 110. However, it will be appreciated that such openings, e.g., 152, 162, 164, 180, 212, 230, 232, and 234, may be offset relative to each other in accordance with other embodiments contemplated herein. Further, the relative positioning of the openings 152, 162, 164, 180, 212, 230, 232, and 234 shown in FIG. 2 is intended only as a non-limiting example, and the orientation and positioning of the openings may be varied without departing herefrom.

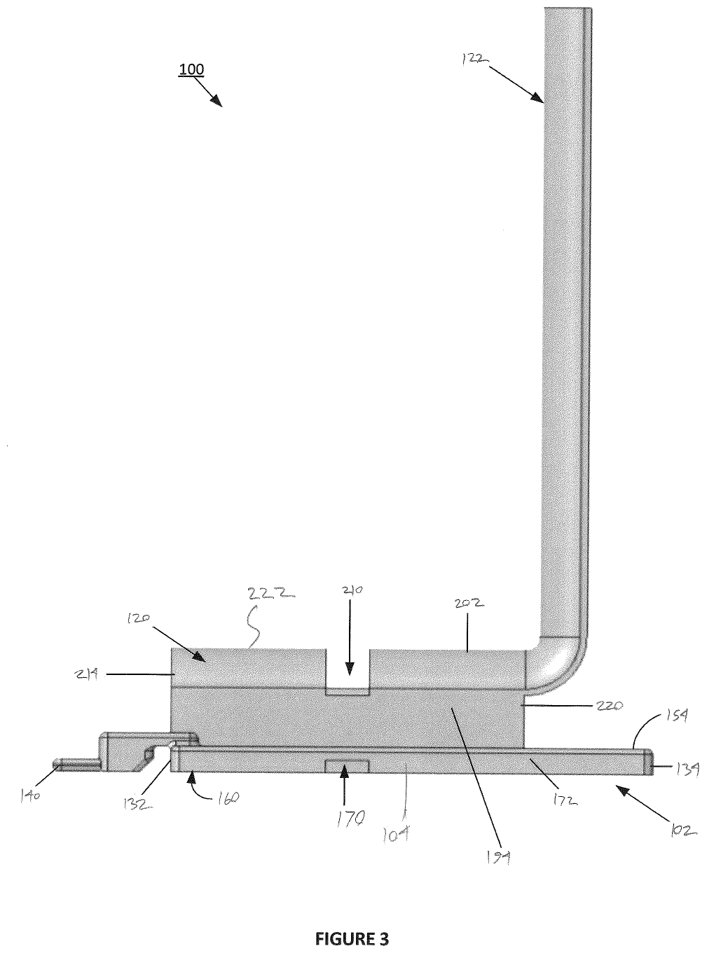

Referring now to FIG. 3, there is illustrated a side view of the BPD unit 100 of FIG. 1 in accordance with some embodiments. As shown in the example embodiment of FIG. 3, the first finger 122 is attached to or formed from the protrusion 120 at the second end 220 of the crossmember 202. In some embodiments, the first finger 122 is integrally formed with the BPD unit 100, such that the top surface 222 of the crossmember 202 curves away from the first substantially planar member 104 and the second substantially planar member 110 to form the first finger 122. In other embodiments, the first finger 122 is attached to the protrusion 120, e.g., adhesive, friction, mechanical, etc.

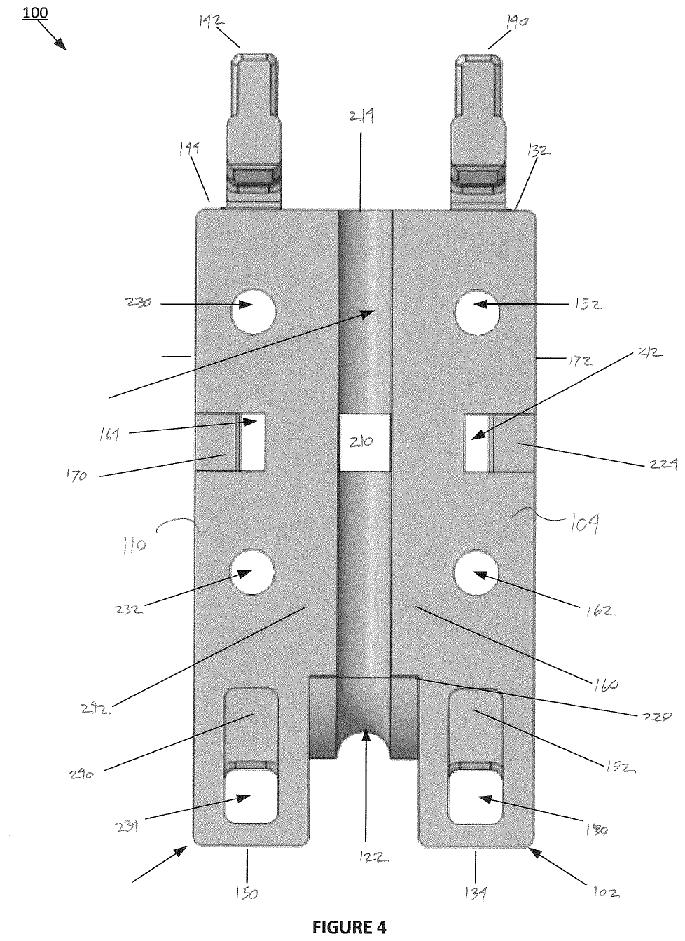

Turning now to FIG. 4, there is shown a bottom view of the BPD unit 100 of FIG. 1 in accordance with some embodiments. As shown in FIG. 4, the first substantially planar member 104 defines the attachment second end indent 192 configured to slideably engage the first link 140 of another BPD unit 100 inserted through the attachment opening 180. Similarly, the second substantially planar member 110 includes an attachment second end indent 240 configured to slideably engage the second link 142 of another BPD unit 100 inserted through the attachment opening 234. As illustrated in FIG. 4, the attachment second end indent 192 is a recess in the bottom surface 160 of the first substantially planar member 104, and an attachment second end indent 240 of the second substantially planar member 110 is a recess in a bottom surface 242 of the second substantially planar member 110.

Referring now to FIGS. 5-7, there are shown, respectively, depicted an isometric view, a front view, and a side view of the second finger 174 of the modular BPD system in accordance with some embodiments. The second finger 174 is an intermediary component fixed with the protrusion 120, where the second finger 174 extends from the protrusion 120 and the platform 102 in the normal direction. As shown in FIGS. 5-7, the second finger 174 includes a body portion 300 and a base portion 302. The second finger 174 further includes a top surface 304, a front surface 310, a back surface 312, a first side 314 and a second side 320. In some embodiments, the body portion 300 and the base portion 302 are integrally formed. In other embodiments, one or more portions of the second finger 174 may be formed in any order and coupled together to form the entirety of the intermediary component.

As shown in FIGS. 5-7, a through slot 322 extends from the first side 314 through the body portion 300 to the second side 320. In some embodiments, the through slot 322 may be configured to receive an attachment mechanism such as a strap, allowing for the second finger 174 to be secured to a utility structure as a standalone component or while attached to the BPD unit 100. The base portion 302 includes a first leg 324 and a second, opposing leg 330, separated by a channel 332. The first leg 324 and the second leg 330 are fixed with the base portion 302, and when engaged with the protrusion 120, the first leg 324 and the second leg 330 extend in the normal direction from the base portion 302, along the first wall 194 and the second wall 200. The first leg 324 and the second leg 330 respectively extend toward the platform 102, and into the intermediary slots 164, 212 in the normal direction.

As shown in FIGS. 5-7, the first leg 324 includes a flange 334 positioned on an exterior distal portion thereof, wherein the flange 334 is configured to be inserted into the intermediary slot 164, 212 of the first substantially planar member 104 or the second substantially planar member 110, respectively. It will be appreciated that the second finger 174 is symmetrical, and as such, may be affixed to the BPD unit 100 with the flange 334 inserted into either of the intermediary slots 164, 212. Further, the second leg 330 includes a flange 340, which is also configured to be inserted into the intermediary slot 164, 212 of the first substantially planar member 104 or the second substantially planar member 110, respectively.

As such, referring back to FIG. 4, the platform 102 defines the second end indents 192, 240 at a side of the platform 102 opposite the first wall 194 and the second wall 200 in the normal direction. The second end indents 192, 240 extend from the intermediary slots 164, 212 in the longitudinal direction or the lateral direction, and the first leg 324 and the second leg 330 respectively include the flanges 334, 340 that respectively engage the intermediary indents 170, 224.

As shown in FIG. 5, the first leg 324 includes an inner surface 342 facing the channel 332, and the flange 334 is a step including a first bottom surface 344 and an interior facing surface 350. It will be appreciated that when installed on the BPD unit 100, the inner surface 342 slideably engages the first wall 194 of the protrusion 120, the first bottom surface 344 rests or contacts the top surface 154 of the first substantially planar member 104, and the interior facing surface 350 slideably engages or contacts a portion of the intermediary slot 164. Further, in some embodiments, a top surface of the flange 334 contacts or engages the intermediary indent 170 when the second finger 174 is attached to the BPD unit 100.

Similarly, the second leg 330 includes an inner surface 354 facing the channel 332, and the flange 340 is a step including a second bottom surface 360 and an interior facing surface 362 adjacent the flange 340. As such, each of the first flange 334 and the second flange 340 is a step that extends from the first leg 324 and the second leg 330, through the platform 102, to a side of the platform 102 opposite the first leg 324, the second leg 330, the first wall 194, and the second wall 200 in the normal direction.

It will be appreciated that when installed on the BPD unit 100, the inner surface 354 slideably engages the second wall 200 of the protrusion 120, the second bottom surface 360 rests on or contacts a top surface of the second substantially planar member 110, and the interior facing surface 350 slideably engages or contacts a portion of the intermediary slot 212. Further, in some embodiments, a top surface of the flange 334 contacts or engages the intermediary indent 224 when the second finger 174 is attached to the BPD unit 100. It will be appreciated that the aforementioned contact points and engagements may be reversed depending upon the orientation of the second finger 174 when coupled to the BPD unit 100.

As such, referring back to FIG. 4, the platform 102 defines the intermediary indents 170, 224 at sides of the first substantially planar member 104 and the second substantially planar member 110 opposite the first wall 194 and the second wall 200 in the normal direction. Also, the intermediary indents 170, 224 extend from the intermediary slots 164, 212 in the longitudinal direction or the lateral direction, and the first leg 324 and the second leg 330 include the flanges 334, 340 that engage the intermediary indents 170, 212.

The channel 332, as illustrated in FIGS. 5-7, is suitably dimensioned to accommodate the protrusion 120 of the BPD unit 100, as shown in FIGS. 8-10. As illustrated in FIGS. 5-7, the base portion 302 may include an arch 364 located in the channel 332. In some embodiments, the arch 364 may correspond to a curved upper surface of the crossmember 202, enabling the channel 332 to securely fit within the window 210. As such, the crossmember 202 is curved in the normal direction, and the base portion 302 defines the arch 364 such that the base portion 302 extends the curved upper surface of the crossmember 202 in the longitudinal direction.

In some embodiments, the width of the second finger 174 is suitably sized to allow for insertion into the window 210, as shown in FIGS. 8-10. In such embodiments, the base portion 302 extends through the crossmember 202 in the lateral direction, such that the base portion 302 overlaps the crossmember 202 in the longitudinal direction at the window 210. With this construction, the base portion 302 is seated on the first wall 194 and the second wall 200 in the normal direction. The first leg 324 and the second leg 330 extend along and contact the first wall 194 and the second wall 200 between the crossmember 202 and the platform 102 in the normal direction. The first leg 324 and the second leg 330 also abut the platform 102 in the normal direction. In this manner, the first leg 324 and the second leg 330 secure the second finger 174 to the platform 102 and the protrusion 120.

With continued reference to FIGS. 8-11, there are shown a variety of views of a modular bird perch deterrent system 400 in accordance with some embodiments. It will be appreciated that while only two BPD units 100 are shown in FIGS. 8-11, (e.g., the first BPD unit 402 and the second BPD unit 404) any number of BPD units 100 may be attached, along with any number of intermediary components as the second finger 174 in accordance with the underlying utility structure to which the system 400 is affixed, the length of perch deterrent needed, or the like.

Referring now to FIG. 8, there is depicted an isometric view of the modular BPD system 400 comprising one or more BPD units 100 (e.g., the first BPD unit 402 and the second BPD unit 404) and second finger 174 in accordance with some embodiments. As shown in FIG. 8, the first BPD unit 402 is removably attached to the second BPD unit 404, such that the first link 140 of the first substantially planar member 104 of the first unit 402 is inserted into the attachment opening 180 of the second BPD unit 404, and the second link 142 of the second substantially planar member 110 of the first unit 402 is inserted into the attachment opening 234 of the second BPD unit 404. In such an embodiment, the top surfaces of the flanges 334, 340 frictionally engage the second end indents 192, 240, respectively, to secure the two units 402 and 404 together. As illustrated in FIG. 8, the first end 132 of the first substantially planar member 104 of the first unit 402 may contact the second end 134 of the first substantially planar member 104 of the second unit 404. Similarly, the first end 144 of the second substantially planar member 110 of the first unit 402 may contact the second end 150 of the second substantially planar member 110 of the second unit 404.

FIG. 8 further illustrates the attachment of the second finger 174 on the first BPD unit 402. It will be appreciated that the second BPD unit 404 may also be equipped with a corresponding second finger 174, and that placement of intermediary components such as the second finger 174 may be dictated by the utility structure or desired deterrent features during installation of the modular BPD system 400. As shown in FIG. 8, the flange 334 of the first leg 324 of the second finger 174 is inserted into the intermediary slot 164 of first substantially planar member 104, such that a top surface of the flange 334 frictionally engages the intermediary indent 170 to secure the second finger 174 to the first BPD unit 402.

Although not visible in FIG. 8, the flange 334 of the second leg 330 of the second finger 174 is inserted into the intermediary slot 164 of second substantially planar member 110, such that a top surface of the flange 334 frictionally engages the intermediary indent 170 to secure the second finger 174 to the first BPD unit 402. As such the platform 102 defines the intermediary indents 170, 212 at a side of the platform 102 opposite the first wall 194 and the second wall 200 in the normal direction. Each of the intermediary indents 170, 212 may respectively extend from the intermediary slots 164, 212 in the longitudinal direction or the lateral direction. The first leg 324 and the second leg 330 include the flanges 334, 340 that respectively engage the intermediary indents 170, 224. It will further be appreciated that as illustrated in FIG. 8, the protrusion 120 is positioned within the channel 332 of the second finger 174, and the second finger 174 is slotted into the window 210.

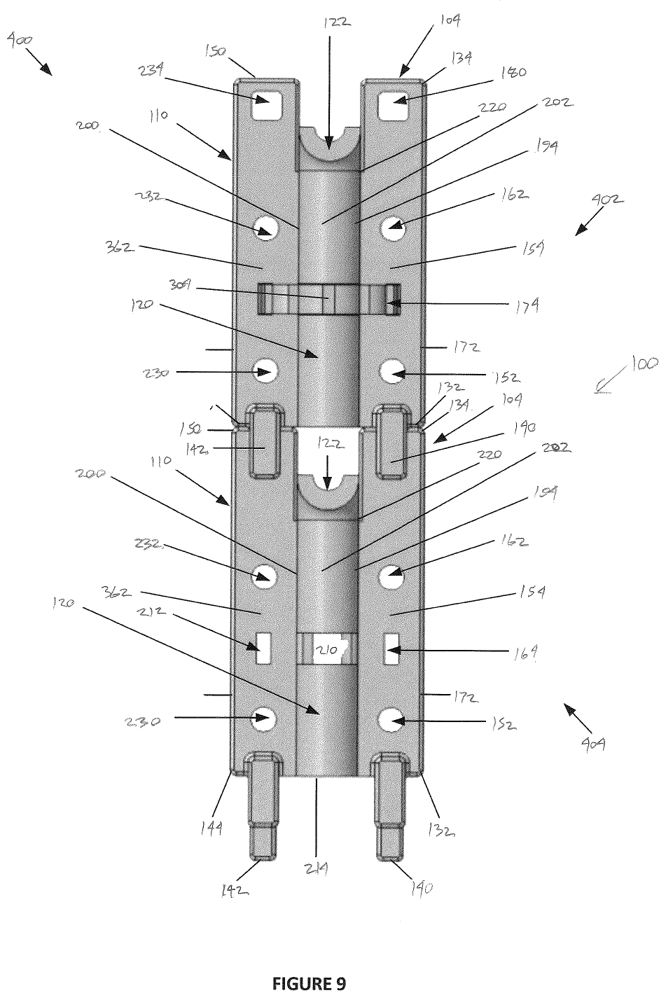

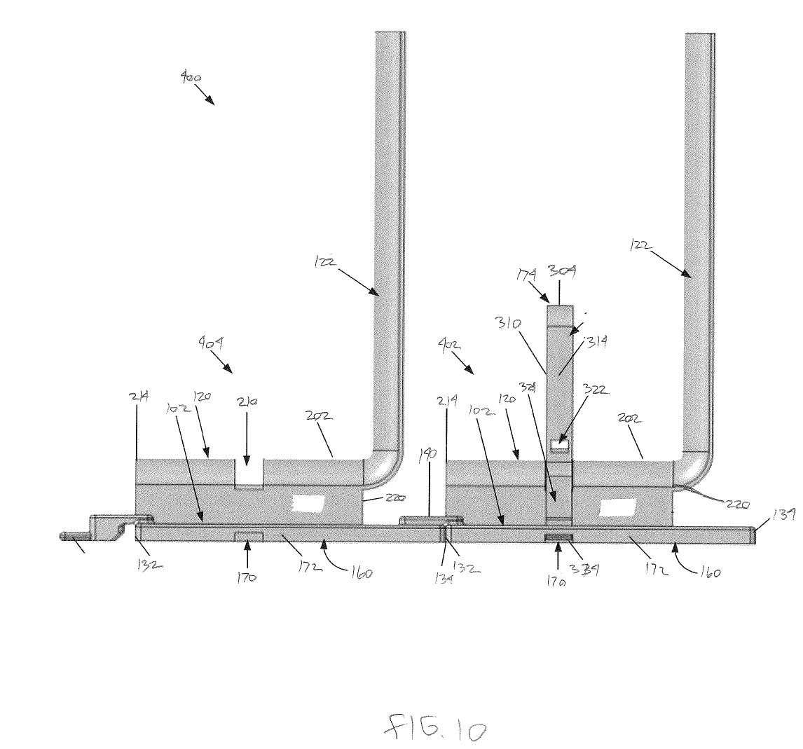

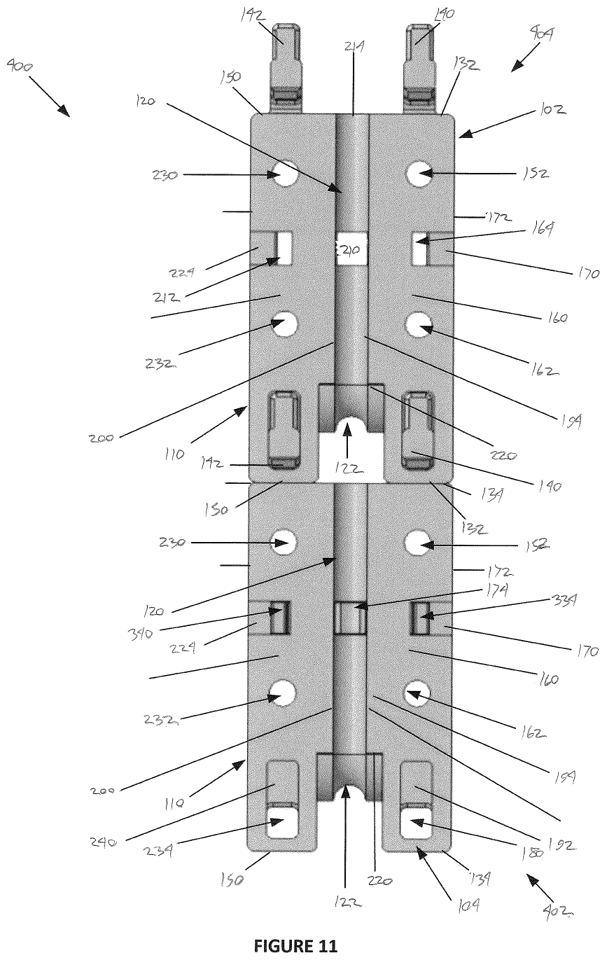

FIG. 9 provides a top view of system 400 of FIG. 8, including the attached BPD units 402 and 404 and the second finger 174. FIG. 10 provides a side view of the BPD units 402 and 404 and the second finger 174 for use in the modular BPD system 400 of FIG. 8. FIG. 11 illustrates a bottom view of the BPD unit system 400 of FIG. 8. As illustrated in FIG. 11, the above-described tabs and flanges (190, 334, 340) and corresponding indents (170, 192, 224, 240) of the first and second BPD units 402 and 404, as well as the second finger 174 of FIG. 8 are shown.

FIGS. 12-18 depict an embodiment of the BPD unit 100 where the first finger 122 is a distinct component fixed with the protrusion 120 in a push down snap-fit assembly. In this regard, as shown in FIG. 12, the protrusion includes a first socket 500 that defines apertures 502. The first socket 500 is fixed to the second end 220 of the crossmember 202, with the apertures 502 extended downward into the first socket 500 in the normal direction.

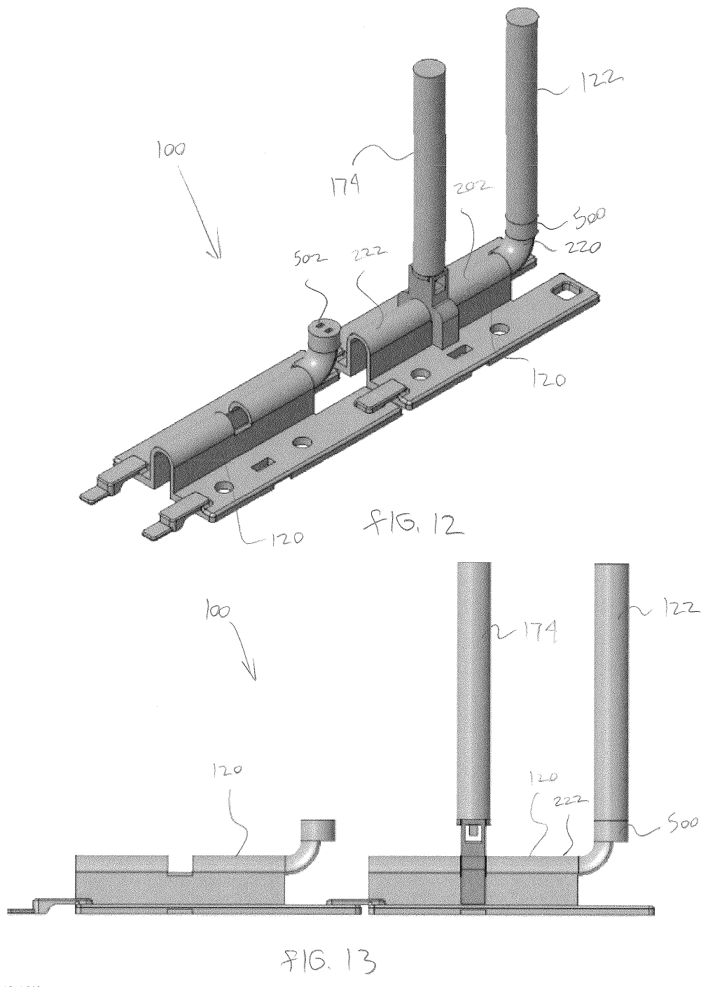

With reference to FIGS. 16 and 17, the first finger 122 includes ears 504 that are received in the apertures 502 in the push down snap-fit assembly. The ears 504 each respectively form an inclined surface and a step that catches the first socket 500 at the apertures 502, retaining the first finger 122 in the first socket 500. In an embodiment, the first finger 122 is permanently fixed with the first socket 500 in the push down snap-fit assembly, such that the first finger 122 cannot be removed from the first socket 500 without damaging at least one of the first finger 122 and the first socket 500. With this construction, the first finger 122 is rigidly secured to the protrusion 120 at the first socket 500 in a relatively durable push down snap-fit assembly.

As shown in FIG. 14, the apertures 502 extend through the first socket 500 in the normal direction. With this construction, the ears 504 may be inserted through and catch the first socket 500 without abutting portions of the first socket 500 or the protrusion 120 in the normal direction.

As shown in FIGS. 12 and 13, the first socket 500 has a circular profile that matches the top surface 222 of the crossmember 202 and an exterior surface of the first finger 122. With this construction, the BPD system 100 has a continuous exterior profile along the crossmember 202, the first socket 500, and the first finger 122.

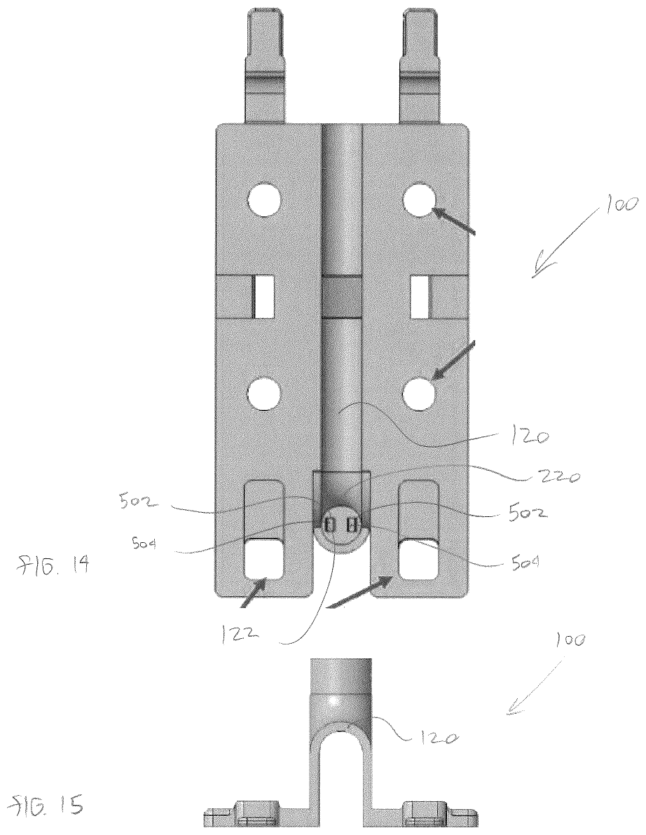

The second finger 174 may include similar features and function in a similar manner as the first finger 122 in the push down snap-fit assembly for connecting the second finger 174 to the protrusion 120. In this regard, as shown in FIG. 18, the base portion 302 forms a second socket 510 that defines apertures 512 configured for receiving ears of the second finger 174. With this construction, each of the first finger 122 and the second finger 174 are interchangeable with each other and optionally assembled with the BPD unit 100 in the push down snap-fit assembly, providing customizable distribution of the first finger 122 and the second finger 174 in an assembly of similar BPD units in the longitudinal direction.

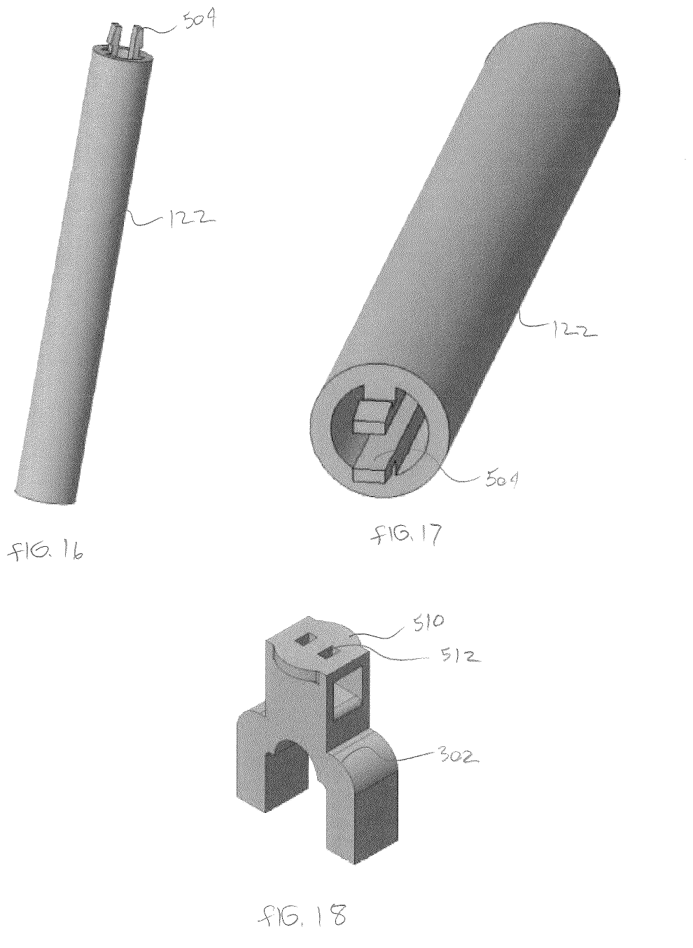

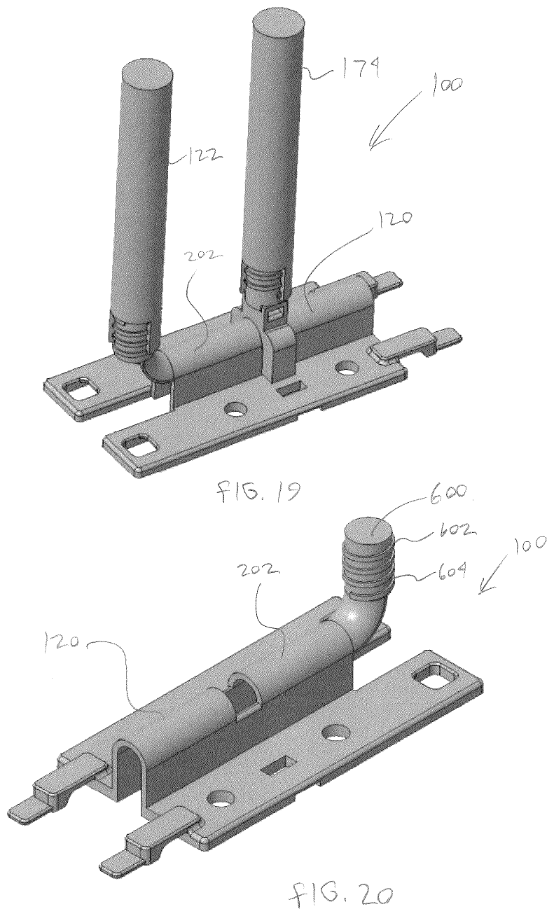

FIGS. 19-22 depict an embodiment of the BPD unit 100 where the first finger 122 and the second finger 174 are distinct components fixed with the protrusion 120 in a threaded assembly. As shown in FIGS. 19 and 20, the crossmember 202 includes a first end portion 600 having first male threads 602 disposed along an exterior surface 604 in the normal direction.

As shown in FIG. 21, the first finger 122 includes female threads 610 disposed along an interior surface 612 in the normal direction. The first male threads 602 and female threads 610 are complementary with each other to fix the first finger 122 with the crossmember 202 at the end portion 600. In an embodiment, the first finger 122 is removably fixed with the protrusion 120 at the end portion 600, such that the distribution of the first finger 122 and the second finger 174 on the BPD unit 100 is adjustable.

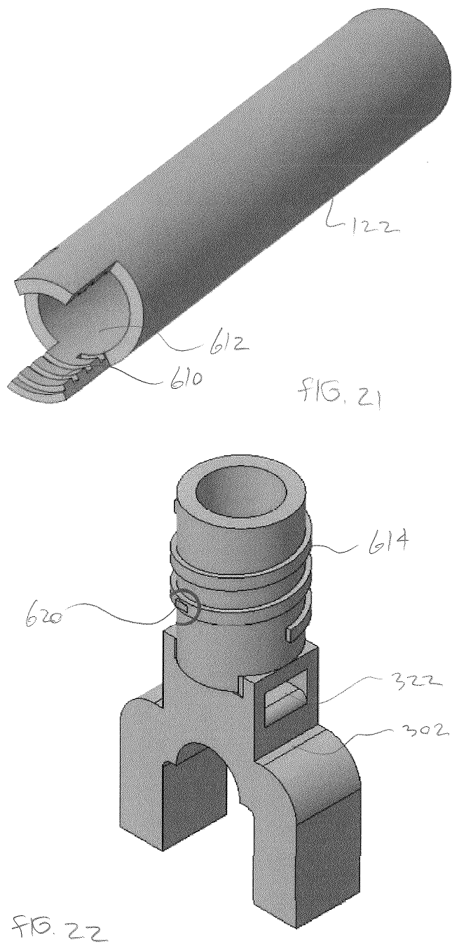

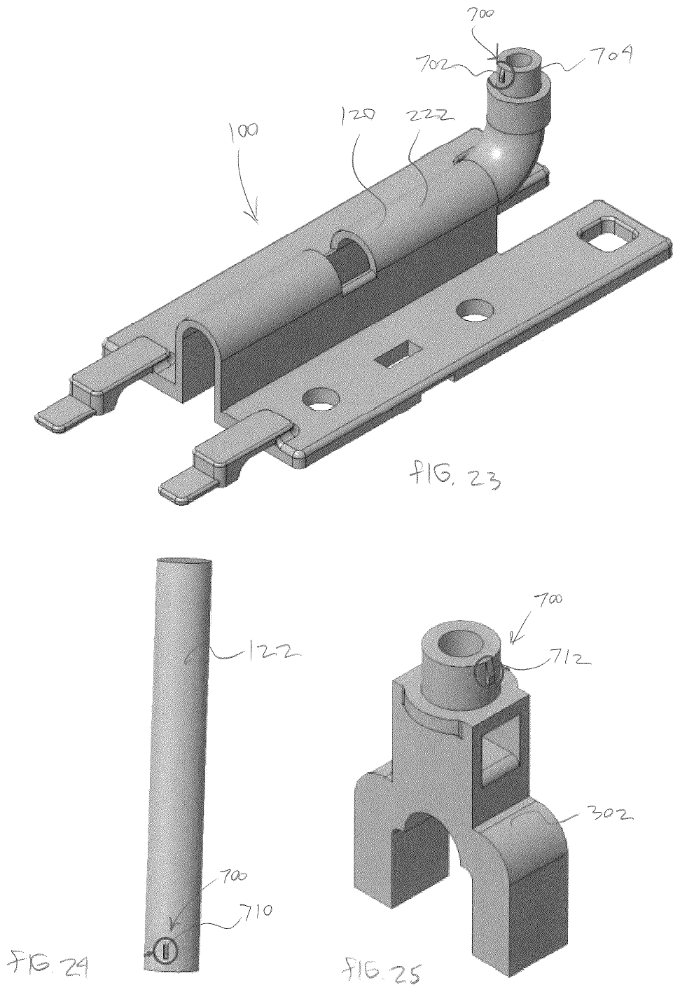

The second finger 174 may include similar features and function in a similar manner as the first finger 122 in the threaded assembly for connecting the second finger 174 to the protrusion 120. In this regard, as shown in FIG. 22, the base portion 302 forms second male threads 614 that are complementary with male threads disposed on the second finger 174 to fix the second finger 174 with the crossmember 202 at the end portion 600. With this construction, each of the first finger 122 and the second finger 174 are interchangeable and optionally assembled with BPD unit 100 in the threaded assembly, providing customizable distribution of the first finger 122 and the second finger 174 in an assembly of similar BPD units in the longitudinal direction.

With continued reference to FIG. 22, the second male threads 614 include a detent 620 as part of a catch mechanism that engages the female threads 610 of the first finger 122, or engages similar female threads of the second finger 174. The detent 620 catches the first finger 122 or the second finger 174 on the second male threads 614, locking the first finger 122 or the second finger 174 on the base portion 302. In an embodiment, the detent permanently fixes the first finger 122 or the second finger 174 to the base portion 302 such that the first finger 122 or the second finger 174 cannot be removed from the base portion 302 without damaging at least one of the first finger 122, the second finger 174, or the base portion 302. In this manner, the BDP unit 100 includes a catch mechanism in the first finger 122, the second finger 174, or the protrusion 120 that locks the first finger 122 or the second finger 174 in the threaded connection with the protrusion.

FIGS. 23-25 depict an embodiment of the BPD unit 100 where the first finger 122 and the second finger 174 are fixed with the protrusion 120 in a press-fit assembly, and retained at the protrusion 120 by a catch mechanism 700. As shown in FIG. 23, the catch mechanism 700 includes a first detent 702 provided on an end portion 704 of the protrusion 120. The end portion 704 is cylindrical, and complementary with the first finger 122 for insertion therein. The first detent 702 extends outward from the end portion 704, forming an incongruity in the cylindrical end portion 704.

As shown in FIG. 24, the first finger 122 defines a catch 710 that receives the first detent 702, fixing the first finger 122 to the protrusion 120 at the end portion 704. In this regard, referring back to FIG. 23, the first detent 702 forms an inclined surface and a step that slide along an interior of the first finger 122 when the end portion 704 is inserted into the first finger 122. The step in the first detent 702 retains the first finger 122 at the catch 710, obstructing removal of the end portion 704 from the first finger 122.

The second finger 174 may include similar features and function in a similar manner as the first finger 122 in the press-fit assembly for connecting the second finger 174 to the protrusion 120. In this regard, as shown in FIG. 25, the base portion 302 includes a second detent 712 having an inclined surface and a step that slide along an interior of the second finger 174 when the base portion 302 is inserted into the second finger 174.

The base portion 302 is cylindrical, and has a size and shape that matches the end portion 704. With this construction, each of the first finger 122 and the second finger 174 are interchangeable and optionally assembled with BPD unit 100 in the press-fit assembly, providing customizable distribution of the first finger 122 and the second finger 174 in an assembly of similar BPD units in the longitudinal direction.

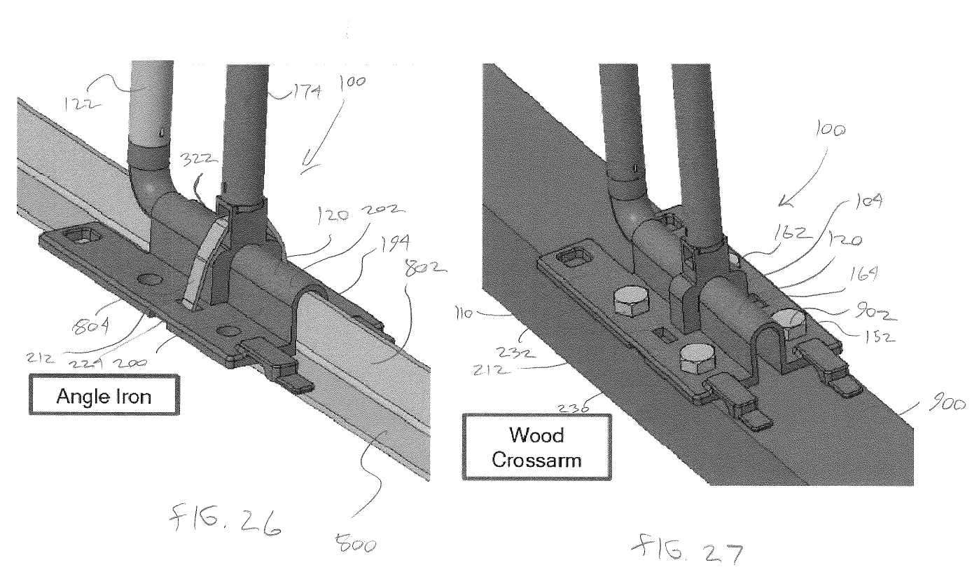

FIG. 26 depicts the BPD unit 100 fixed with a segment of angle iron 800. As shown in FIG. 26, the angle iron 800 includes a rib 802 extended through the protrusion 120 in the longitudinal direction. In this regard, the first substantially planar member 104 and the second substantially planar member 110 are each seated on the angle iron 800, wherein the first wall 194, the second wall 200, and the crossmember 202 extend above and over the rib 802.

The BPD unit 100 includes a strap 804 extended around the second finger 174, the protrusion 120, and the platform 102 in the normal direction and the lateral direction. More specifically, the second finger 174 and the platform 102 define closed passages that receive the strap 804 around the angle iron 800 and the BPD unit 100. In this regard, the strap 804 is received by the through slot 322 defined in the second finger 174, and by the intermediary slots 164, 212, where the strap 804 wraps around and fixes the BPD unit 100 to the angle iron 800 through the platform 102 and the second finger 174.

Each of the closed passages formed from the through slot 322 and the intermediary slots 164, 212, and the window 210 are defined with a same position in the longitudinal direction. With this construction, the strap 804 may extend straight through the second finger 174 and the platform 102 in the lateral direction.

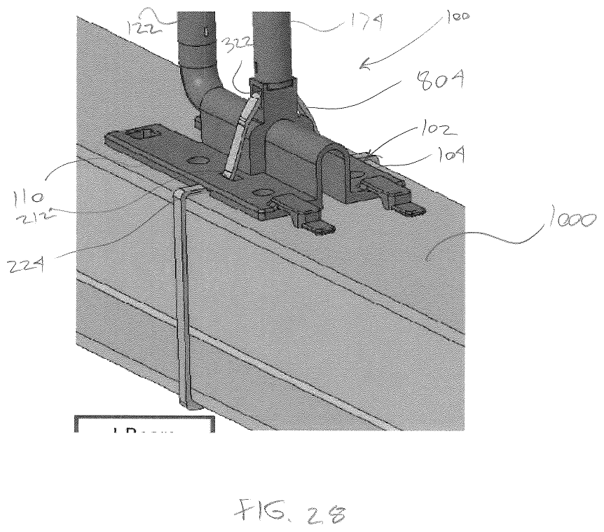

FIG. 27 depicts the BPD unit 100 fixed to a wood crossarm 900. In this regard, fasteners 902 extend through the first holes 152, 230 and the second holes 162, 232 and into the wood crossarm 900 in the normal direction. As such, the fasteners 902 fix the BPD unit 100 to the wood crossarm 900 through the platform 102, at the first substantially planar member 104 and the second substantially planar member 110.

FIG. 28 depicts the BPD unit 100 fixed to an I-beam 1000. In this regard, the strap 804 is wrapped around the I-beam 1000, where the strap 804 extends through the through slot 322 at the second finger 174, through the intermediary slots 164, 212 in the platform 102, and through the intermediary indents 170, 224 in the platform 102. More specifically, the platform 102 is seated on the I-beam 1000, and the strap 804 extends between the platform 102 and the I-beam 1000 through the intermediary indents 170, 224. With this construction, the platform 102 lays flat on the I-beam 1000, over the strap 804.

While specific embodiments are shown and described herein, it is contemplated that alternative embodiments exist that employ alternative materials, mixtures, proportions, sizes, etc. without departing from the spirit and/or scope of the innovation as described in detail. These alternative embodiments are to be included within the spirit and scope of the innovation as described and claimed herein.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A bird perch deterrent system comprising:
a platform;
a protrusion fixed with the platform, the protrusion including:
a wall extended from the platform in a normal direction, and along the platform in a longitudinal direction substantially perpendicular to the normal direction; and
a crossmember fixed along the wall in the longitudinal direction, and extended from the wall in a lateral direction substantially perpendicular to the longitudinal direction and the normal direction, wherein the crossmember extends from an end of the wall opposite the platform in the normal direction; and
a finger fixed with the protrusion, wherein the finger extends from the protrusion and the platform in the normal direction.

2. The system of claim 1, wherein the platform includes a first planar member and a second planar member that extend in the longitudinal direction and the lateral direction,
the wall is a first wall fixed with the first planar member,
the protrusion includes a second wall fixed with the second planar member, and
the crossmember connects the first wall and the second wall at opposite ends of the crossmember in the lateral direction.

3. The system of claim 1, wherein the finger is integrally formed with the crossmember, the crossmember and the finger form a continuous bent profile, the crossmember forms the bent profile in the longitudinal direction, and the finger forms the bent profile in the normal direction.

4. The system of claim 3, wherein at the crossmember, the bent profile extends away from the wall and the platform in the normal direction, and is curved or angled in the normal direction.

5. The system of claim 1, wherein the crossmember defines a window through the protrusion in the normal direction, the platform defines a slot that is a through hole extended in the normal direction, and the window and the slot are defined in a same position in the longitudinal direction.

6. The system of claim 5, wherein the finger is a first finger, the system further comprises a second finger extended from the protrusion and the platform in the normal direction, and the second finger includes:
a base portion that extends through the crossmember in the lateral direction, such that the base portion overlaps the crossmember in the longitudinal direction at the window; and
a leg fixed with the base, wherein the leg extends in the normal direction from the base, along the wall, toward the platform, and into the slot.

7. The system of claim 6, wherein the platform defines an indent at a side of the platform opposite the wall in the normal direction, the indent extends from the slot in the longitudinal direction or the lateral direction, and the leg includes a flange that engages the indent.

8. The system of claim 7, wherein the flange is a step that extends from the leg, through the platform, to a side of the platform opposite the leg and the wall in the normal direction.

9. The system of claim 6, wherein the base portion is seated on the wall in the normal direction, the leg extends along and contacts the wall between the crossmember and the platform in the normal direction, and the leg abuts the platform in the normal direction.

10. The system of claim 1, wherein the crossmember includes a first end and a second end in the longitudinal direction, the finger is a first finger located at the second end, and the system further comprises a second finger fixed with the crossmember at a location closer to a midpoint between the first end and the second end as compared to either the first end or the second end.

11. The system of claim 1, wherein the crossmember is curved in the normal direction, the finger includes a base portion supported on the wall, and the base portion defines an arch that extends a curved surface of the crossmember in the longitudinal direction.

12. The system of claim 1, wherein the platform, the wall, the crossmember, and the finger are integrally formed with each other.

13. The system of claim 1, further comprising a link at a first end of the platform in the longitudinal direction, the link including:
a bridge extended beyond the first end of the platform in the longitudinal direction, wherein the bridge is offset from, and clear of the platform in the normal direction, and
a lug fixed with the bridge at an end of the bridge opposite the platform in the longitudinal direction.

14. The system of claim 13, wherein the platform includes a second end opposite the first end in the longitudinal direction, the platform defines an opening extended in the normal direction, and the opening is located closer to the second end of the platform as compared to the first end.

15. The system of claim 14, wherein the opening and the lug form similar shaped surfaces in the normal direction, and are sized to engage each other in a snug fit relationship that obstructs relative rotation between the lug and the platform.

16. The system of claim 14, wherein the bridge spaces the lug from the first end by a first distance in the longitudinal direction, and the opening is spaced from the second end by a second distance in the longitudinal direction less than the first distance.

17. The system of claim 14, further comprising a tab fixed with the lug, wherein the tab extends from the lug and the platform in the longitudinal direction, the platform defines an indent at a side of the platform opposite the wall in the normal direction, the indent extends from the opening in the longitudinal direction or the lateral direction, and the tab engages the indent.

18. The system of claim 1, wherein the finger is fixed to the protrusion through a threaded, press-fit, or snap-fit connection, and the system further comprises a catch mechanism that locks the finger in the threaded, press-fit, or snap-fit connection with the protrusion.

19. The system of claim 1, wherein the finger is a first finger, and the system further comprises:
a second finger extended from the platform and the protrusion in the normal direction, wherein the second finger is spaced from the first finger along the crossmember in the longitudinal direction; and
a strap extended around the second finger, the protrusion, and the platform in the normal direction and the lateral direction.

20. The system of claim 19, wherein the second finger and the platform each define a closed passage that receives the strap, and the crossmember defines a window through the protrusion,
the second finger includes a base portion that extends through the window, where the base portion is supported on the wall in the normal direction, and obstructed from movement in the longitudinal direction by the crossmember, and
each of the closed passages and the window are defined with a same position in the longitudinal direction.
